(19) United States
(12) Patent Application Publication
(10) Pub. No.: US 2022/0163746 A1
(43) Pub. Date: May 26, 2022

(54) OPTICAL FIBER CONNECTOR DEVICE

(71) Applicant: Telecom & Security S.R.L., Manoppello (IT)

(72) Inventors: Giovanni Pugliese, Manoppello (IT); Alfredo Ventrella, Manoppello (IT)

(21) Appl. No.: 17/601,046

(22) PCT Filed: Apr. 6, 2020
(86) PCT No.: PCT/IT2020/050088

§ 371 Date: Oct. 1, 2021

(30) Foreign Application Priority Data
Apr. 4, 2019 (IT) 102019000005080

(51) Int. Cl. G02B 6/44; G02B 6/50; G02B 6/38

(52) U.S. Cl. CPC G02B 6/4463; G02B 6/3847; G02B 6/508

(57) ABSTRACT

The present disclosure relates to a connector device for optical fiber configured to allow the transmission of an optical signal at a terminal end of the fiber in a cabling condition. The device comprises a portion of optical fiber having a ferrule at at least one terminal end, a ferrule holder element and a protective element for the optical fiber. The overall configuration is such that the connector device has small radial and longitudinal dimensions which, in an operating condition, allow rapid movement within wiring cables or tubular ducts, for example cable ducts, pipes, conduits etc., which due to their sizes, hinder the passage of standard connectors of known type.

### INCORPORATION BY REFERENCE TO ANY PRIORITY APPLICATIONS

This application is the U.S. National Phase of International Application PCT/IT2020/050088, filed Apr. 6, 2020, which claims the benefit of priority to Italian Application No. 102019000005080, filed on Apr. 4, 2019, the disclosures of each of which are hereby incorporated by reference in their entireties. Any and all applications for which a foreign or domestic priority claim is identified in the Application Data Sheet as filed with the present application are hereby incorporated by reference under 37 CFR 1.57.

### BACKGROUND

### Field

The present invention relates to a connector device for optical fiber, i.e. a device for terminating optical fiber cables that require connection and/or disconnection.

### Description of the Related Art

The optical fiber cables include a central optical fiber in glass, or plastic material, suitable for transmitting the light signal, an internal protective sheath in Nylon, Kevlar fibers, which are used to strengthen the cable by increasing its tensile strength, and an outer sheath in plastic or rubbery material.

The connections between the terminations of fiber optic cables must be made with great precision to allow the passage of the light signal from one optical fiber to another with the least possible dispersion.

In general use, the cables for optical fibers are provided at the terminal ends with standard male type connectors, so that two cables can be joined together by means of a female-female connection element, also of a standard type.

These connectors make direct contact between the ends of two fibers by exerting a force which tends to keep these ends together.

Optical fibers can be of different types, generally singlemode or multimode, depending on the signal bandwidth to be transmitted and the length of the optical link.

Fiber optic connectors can also be of different types, for example SC or LC or FC or ST or MU or others, depending on the application in which they are to be used.

Finally, the connections between fiber optic cables can also be of different types, such as PC (Physical Contact) or UPC (Ultra Physical Contact) or APC (Angled Physical Contact).

In the APC connection, for example, the normal to the terminal surface of the fiber forms a predefined angle with a longitudinal axis of the fiber, generally 8 degrees, in order to minimize the reflection of the optical signal at the interface along the axis of the fiber itself.

In these cases, the connection must also guarantee the precise mutual orientation of the fibers around their common axis, so that the terminal surfaces of the fibers are parallel and can therefore be overlapped and connected directly with an axial movement obtained by the action of a spring.

Precise connections between optical fibers can be made by a technician on-site.

Generally, they can be made by means of fusion splicing connectors or “cold” welding connectors.

The fusion splicing provides high quality connections, but require a lot of time (typically 15-20 minutes) and expensive tools, such as a welding machine for optical fibers.

Cold connections, on the other hand, are relatively simpler to make but have the drawback of using more expensive connectors and offer lower quality results.

A different way to operate with fiber optic cables is, as mentioned above, to use cables for optical fibers already provided at the ends with standard male type connectors.

Both in the case of new installations, and in the case of existing installations, for example when fiber optic cables have to replace old copper cables, fiber optic cables have to pass through conduits and passages typically with linear and curved sections.

Often these are corrugated pipes, arranged on site to house copper cables, inadequate for the passage of the optical fiber.

In other cases, these are pipes in which fiber optic cables must coexist with copper cables, for example used in the electricity distribution network.

A disadvantage of known connections is that the passage and installation of fiber optic cables through narrow pipes or in similar conduits are hampered by the connectors at their ends which have radial dimensions typically much larger than the cross sections of the optical fiber cables.

The radial encumbrance of the terminal part of optical fiber cables of known type is therefore a problem in many installations, in particular in those where existing passageways or spaces shared with other wiring must be used.

A further disadvantage is that the installation that involves the passage of fiber optic cables in pre-existing corrugates and the manual construction of standard connectors at their ends can be complicated and require skilled labor, involving high costs and lots of time.

### SUMMARY

Therefore, the technical problem given and solved by the present invention is that of providing a connector device and a connection system for optical fiber cable, which allow to overcome the drawbacks mentioned above with reference to the prior art.

This problem is solved by a connector device specified herein and, according to the same inventive concept, by a connector system specified herein and by the kit specified herein. The present invention also relates to an assembling method for the aforementioned system connector specified herein.

Preferred features of the present invention are specified herein.

The present invention provides some relevant advantages.

In particular, the characteristic of having small radial and longitudinal dimensions comparing to the solutions of known type allows an easy movement of the connector device for fiber optic cable during cabling and/or insertion in pre-existing corrugates.

A further advantage is that the connector device according to the present invention allows protection of the optical fiber by preventing unwanted bending or warping of the fiber, in particular in the area of connection with the ferrule.

The possibility of assembling the connector device at the factory, and therefore anticipating it with respect to the cabling phase, allows to obtain a high level of quality control of the assembled components.

Therefore, the functionality of the cables is also tested and characterized at the factory.

Furthermore, advantageously, during the assembly phase, the user does not require specific equipment.

A still further advantage is that the pre-assembled connector device eases the assembly of the connector system.

The system according to the present invention is in fact uniquely assembled, making it possible to assemble it even with unskilled workers.

Moreover, advantageously, the method according to the present invention allows to simplify and speed up the cabling and installation operations of a connector system for fiber optic cable.

Other advantages, characteristics and usage methods of the present invention will become clear from the following detailed description of some embodiments, presented by way of example and without limitation.

### BRIEF DESCRIPTION OF THE DRAWINGS

Reference will be made to the figures of the attached drawings, in which:

FIG. 1 shows an exploded perspective view of an embodiment of the connector device according to the present invention;

FIG. 2 shows a perspective view of the connector device of FIG. 1, in an assembled configuration;

FIG. 3 shows a detail of FIG. 2;

FIG. 4 shows a side view of the device of FIG. 2;

FIG. 4′ shows a side view of a further embodiment of the device of FIG. 2;

FIG. 5 shows a section view of FIG. 4;

FIG. 5a shows an enlarged detail of FIG. 5;

FIG. 5′ shows a section view of FIG. 4′;

FIG. 5a′ shows an enlarged detail of FIG. 5′;

FIG. 6 shows a perspective view of an alternative embodiment of the connector device according to the present invention;

FIG. 7 shows a perspective view of the connector device of FIG. 6 in a usage configuration;

FIG. 8 shows a perspective view of an embodiment of the connector system according to the present invention in a partially assembled configuration;

FIG. 9 shows a perspective view of the system of FIG. 8 in a further partial assembly configuration;

FIG. 10 shows a perspective view of the system of FIG. 9 in a still further configuration of partial assembly;

FIG. 11 shows an exploded perspective view of a detail of the system of FIG. 8;

FIG. 11a shows a further perspective view of a detail of FIG. 11;

FIGS. 12a and 12b show a side section view of the system of FIG. 10 in subsequent assembly steps;

FIG. 12c shows a side view of the system of FIG. 10 in an assembled configuration;

FIGS. 12a′ and 12b′ show a sectional side view of a further embodiment of the system according to the invention in subsequent assembly stages;

FIG. 12c′ shows a side view of a further embodiment of the system according to the invention in an assembled configuration;

FIG. 13 shows a side view of the system according to the present invention in a partially assembled configuration;

FIG. 14 shows a side view of the system of FIG. 13 in an assembled configuration;

FIG. 15 shows a section view of the system of FIG. 14;

FIG. 16 shows a perspective view of a detail of FIG. 13;

FIG. 16a shows an exploded view of the detail of FIG. 16;

FIG. 17 shows a block diagram of the phases of an embodiment of the assembly method according to the present invention.

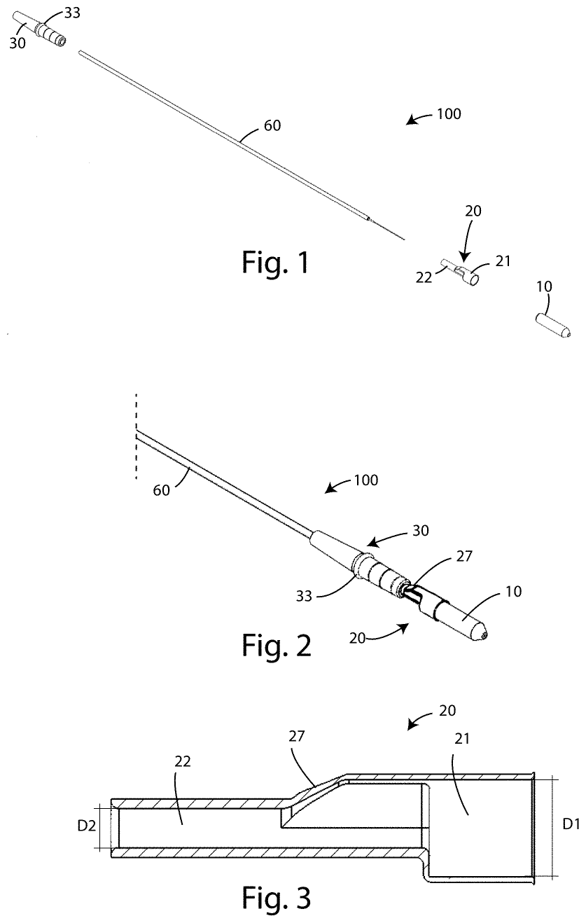

### DETAILED DESCRIPTION

With reference to the figures, a connector device for optical fiber according to a first preferred embodiment of the invention is denoted as a whole with 100. A further embodiment of the device according to the invention will be denoted below with 101′.

The elements that the various embodiments have common will be denoted below with the same numbering.

The connector device 100, 100′ in this example is configured to allow, via an optical sleeve, for example a female-female connector, the transmission of an optical signal at one end of the fiber towards another fiber already connectorized.

The device 100, 100′ comprises a portion of optical fiber 60 having a ferrule 10 at at least one terminal end.

As shown in FIGS. 2 and 3, the device 100, 100′ described herein also provides a ferrule holder element 20.

The ferrule holder element 20, as shown in the enlargement of FIG. 3, is shaped like a double hollow cup comprising a first cup 21, having an internal diameter D1 shaped to house a proximal portion of the ferrule 10, and a second cup 22, coaxial to the former, having an internal diameter D2 smaller than D1, shaped to house the optical fiber 60 so as to direct a coupling with the ferrule 10.

In particular, the first cup 21 is sized to house a proximal portion of the ferrule 10 in a shape coupling.

In the example described here, the ferrule holder 20 has a reference protuberance 27 on an external surface of the first cup 21.

As shown in FIG. 3, the protuberance 27, for example shaped as a reference tooth, extends longitudinally from an external diameter of the second cup 22 to an external diameter of the first cup 21.

Therefore, the configuration of the ferrule holder 20 of the device according to the invention is such as to have a small maximum radial size, for example substantially equal to the external diameter of the second cup 22, which in an operating condition allows easy movement of the device itself into tubular ducts, for example cable ducts, conduits, etc. and facilitating cabling operations.

Advantageously, the maximum radial dimensions of the ferrule holder 20, equal to the external diameter of the second cup 22, is comprised between 2.6 mm and 3 mm, in particular between 2.6 mm and 2.8 mm, preferably equal to 2.7 mm.

Is also provided a substantially cylindrical protection element 30, 30′ slidably coupled to the optical fiber 60 and shaped to be positioned or positioned partially superimposed on at least a portion of the second cup 22. In particular, as shown in FIGS. 5 and 5a, and 5′ and 5a′, the protection element 30, 30′ has an internal end diameter sized to house an edge portion of the second cup 22 of the ferrule holder 20 in a shape coupling.

In this way, advantageously, the optical fiber is protected in particular at the coupling area between the optical fiber 60 and the ferrule holder 20.

The substantially cylindrical body of the protection element 30, 30′ has a maximum external diameter substantially smaller than the external diameter of the ferrule holder 20, so as not to interfere on the external radial dimensions of the device 100, 100′, in particular at the coupling area between the optical fiber 60 and the ferrule holder 20.

In this area, due to the difference in rigidity between the fiber 60 and the ferrule holder 20, is mainly concentrated the possibility of breakage, or the possibility of unwanted bending, of the fiber 60, which precludes its correct operation.

Advantageously, the presence of the element 30, 30′ allows to contain the flexure of the fiber 60 with respect to the ferrule holder 20, providing protection of the aforementioned area and considerably reducing the possibility of fiber breakage especially during the passage of the fiber through paths with small curvature radii, in particular without interfering with the radial dimensions of the ferrule holder.

Furthermore, the overall configuration of the device 100, 100′ is such as to have a reduced size, as well as in the radial direction, also in the longitudinal direction (due to the partial overlapping of the protection element 30 onto at least a portion of the second cup 22), allowing, in an operating condition, an easy movement of the device 100, 100′ inside of tubular ducts, in particular at curved ducts.

In particular, the protection element 30, 30′ is made of elastic material, in particular of plastic material, for example of rubber, in such a way as to allow flexibility and reduction of the longitudinal dimensions during the installation and cabling phases of the device.

Advantageously, the protection element 30, 30′ can comprise a reference element 33, 33′ on the external surface, to indicate a correct mounting position in an assembly configuration of the protection element 30, 30′ with respect to a thrusting element of the connector system according to the invention, as will be more detailed below.

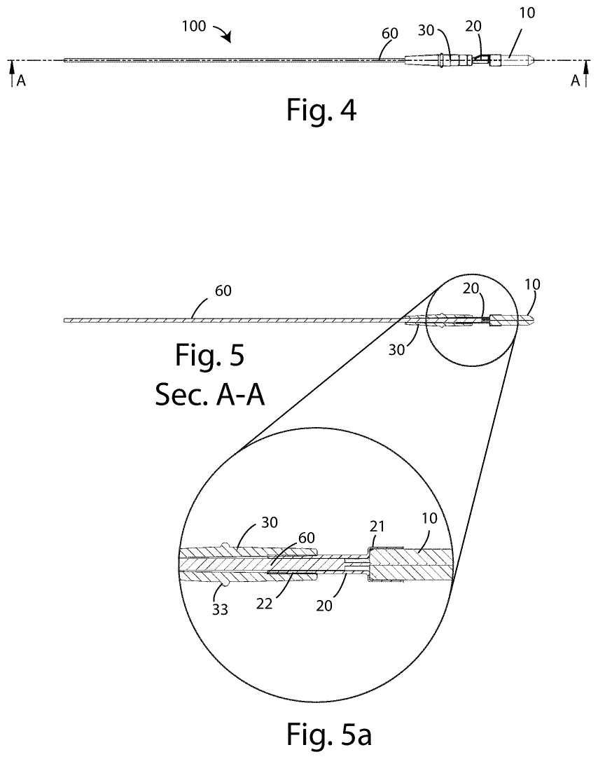

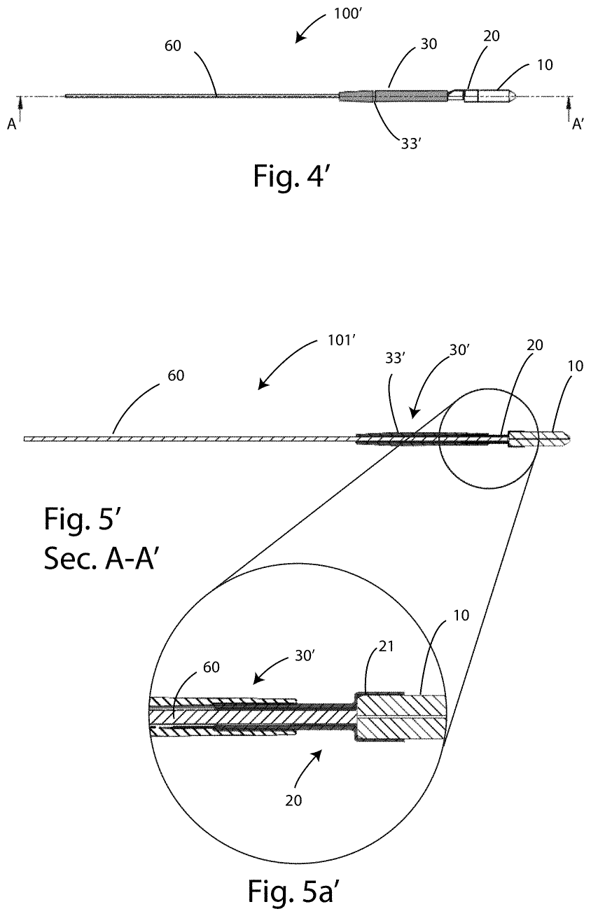

Preferably, the reference element 33′ is configured as a groove made on the cylindrical surface of the protection element 30′, as shown in FIGS. 4′ and 5′.

Alternatively, as shown in FIGS. 4 and 5, the protection element 30 comprises a reference element 33 configured as a protuberance. The protuberance 33, shaped like a circular crown, has a minimum extension both in radial and longitudinal direction, for example 0.1 mm, so to minimize both the impact on the overall radial overall dimensions of the device 100, and the impact on the longitudinal flexibility characteristics of the protection element 30.

Advantageously, to facilitate the handling operations of the connector device 100, 100′ during the installation of the optical fiber, for example in the phase of passage from one end to the other of a corrugated, a dragging assembly 170 is provided.

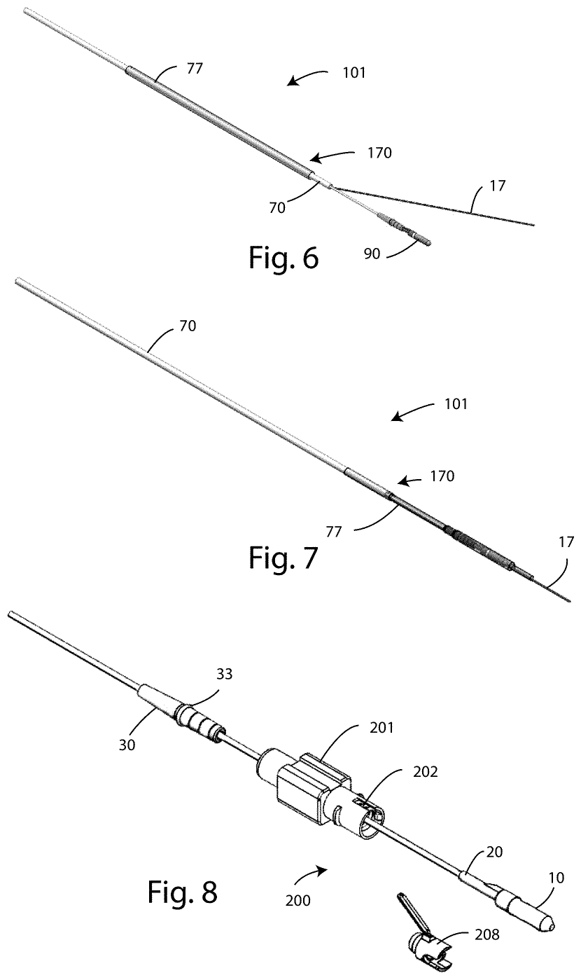

In particular, in an alternative embodiment of the device according to the present invention denoted with 101, shown in FIGS. 6 and 7 (only the device 100 is shown in the figures, but the same towing assembly is also applicable to the device 101′), the dragging assembly 170 comprising a dragging cable 17, preferably in kevlar, which is coupled to the optical fiber, and a tubular sheath 77, for example heat-shrinking, which keeps the optical fiber coupled to the towing cable while maintaining the radial dimensions of the device 101 contained.

In particular, as shown in FIG. 7, in a usage configuration of the device 101, the dragging cable 17 has a protruding end from the sheath 77 and from the ferrule 10, to facilitate and ensure the grip of the device 101 during handling in the corrugated or tubular conduit.

During the cabling phase, once the connector device 101 is inserted inside a tubular conduit, and passed from one end of the conduit to the other, the towing element 17 can be easily removed, for example by removing the thermo-shrinking sheath 77 which has a pre-cut to facilitate the removal. As shown in FIG. 6, the connector device 101 further comprises an external plastic sheath 70, for a further protection of the optical fiber 60, and a covering element, for example a top or cap 90, so-called ferrule protector.

The top or cap 90, which is provided or foreseeable even in an embodiment of the device 100, 100′ without the external plastic sheath 70, is shaped to be positioned in coupling with the ferrule 10 to protect the distal end of the ferrule 10 and the transmission ending surface of the optical fiber 60, and to prevent the surfaces from getting dirty or damaged during the final assembly of the connector.

The present invention also relates to a connector system 1000.

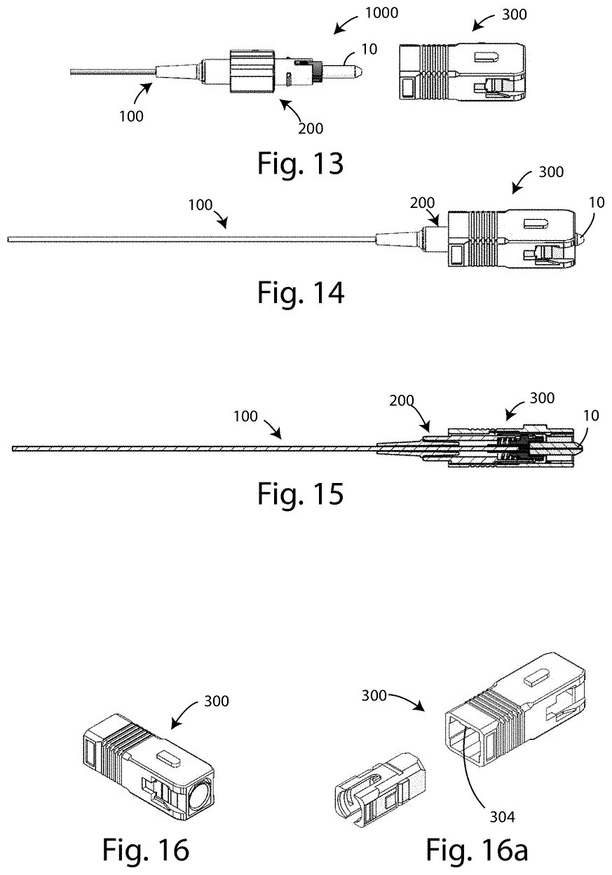

As shown from FIG. 13 to FIG. 15, the connector system 1000 comprises the connector device 100, 100′ or 101 described above, a termination element 300 configured to be coupled to an optical sleeve for the transmission of an optical signal between the ends of two fibers, and thrusting means 200, positioned or positionable between the connector device 100, 100′ or 101, and the termination element 300, configured to exert an elastic force on the ferrule 10.

In the embodiment described here, as shown in the exploded view of FIG. 11, the thrusting means 200 comprise a pusher element 201, in particular having a substantially tubular conformation with a housing A at a terminal portion.

The thrusting means 200 further comprises a thrust-bearing element 208 having a substantially tubular shape and having a longitudinal opening 80, as shown in FIG. 11a, configured to allow its mounting on the optical fiber 60, as better described below.

In the example described here, the thrust element 208 comprises a main body 88 in the shape of a hollow cup, sized to house the ferrule holder 20 and to abut against the ferrule holder 20 at a circular base crown of the cup 88.

In particular, a lateral surface of the hollow cup 88 provides a slot 28 shaped to be coupled to the protuberance 27 of the ferrule holder 20 so as to prevent relative rotations, both during assembly and during use.

Advantageously, the thrust bearing element 208 is preferably made of plastic material and is sized so as to deform plastically, once coupled to the ferrule holder 20, so as to prevent a longitudinal decoupling between the ferrule holder 20 and the thrust bearing 208 during the assembly of the connector system 1000.

Furthermore, advantageously, the thrust-bearing element 208 comprises a further reference element 81, for example a tooth or a protuberance, shaped to align the thrust-bearing element 208 with the thrusting element 201 in an assembly step of the connector system 1000, as will be described below.

To facilitate the assembly operations and the maneuverability of the thrust-bearing element 208, a gripping element 18 is provided, preferably removable after assembly.

In particular, as shown in FIGS. 11 and 11a, the gripping element 18 is connected to the further reference element 81 so as to guide its correct positioning during assembly.

Advantageously, as shown in FIG. 11, the thrusting element 201 has a longitudinal opening, or slot, 207 at a lateral surface of the housing A.

The opening 207 is substantially rectangular and is sized to house the further reference element 81 made on the thrust bearer 208, in such a way as to allow an alignment between the two components, both during assembly and coupling between the thrusting element 201 and the thrust bearer 208, and during the subsequent use of the 1000 system.

As shown in the exploded view of FIG. 11, the thrusting means 200 further comprise an elastic element 202, in particular a spring, positioned or positionable at said housing A and configured to transfer an elastic thrust to the ferrule 10, via the thrust-bearing element 208 and the ferrule holder 20, in an assembled configuration of said system 1000.

In FIGS. 11 and 11a, it is also shown that a proximal portion of the thrust bearer 208 has an abutment base 8 sized to be positioned, or positionable, in contact with the elastic element 202, in a configuration of partial insertion of the thrust-bearing element 208 in the housing A of the pusher element 201.

In particular, the elastic element 202 is sized to be inserted in the housing A and to transfer to the thrust bearer 208 in the first instance, and to the ferrule holder 20 via the thrust bearer 208, an elastic thrust such as to allow, in an assembly configuration of the system 1000 shown in FIGS. 14 and 15, that a terminal end of the ferrule 10 is preferably in an external position, or at most aligned, with respect to a distal end of the termination element 300.

In this way, in a connected configuration between the terminations of two fiber optic cables, the contact between the two distal ends of the ferrules arranged each at the two terminations is guaranteed.

In particular, in a mounting configuration of the system 1000 in a female-female connector, the overall configuration of the elastic means 200 and the compression of the elastic element 202 in a mounting configuration guarantee contact of the end of the ferrule 10 with a further ferrule end.

As shown in FIG. 11, the thrusting element 201 comprises one or more retaining teeth 203, positioned on the internal surface of the housing A, functioning as a bond to a longitudinal displacement of the spring 202 in the seat of the housing A.

The teeth 203 are sized in such a way as to allow the insertion of the spring 202 inside the seat A and at the same time so as to prevent it from coming out during the connector assembly phase. Advantageously, in this way it is possible to decrease the number of pieces to be assembled in the cabling phase.

Advantageously, also the termination element 300, shown in FIG. 16, is preferably provided in the assembled configuration, so to make assembly operations of the connector system 1000 easier and faster.

In particular, as shown in exploded view in FIG. 16a, the pre-assembled termination element 300 comprises an external casing, which defines the external coupling structure of the connector system, and an internal casing, which allows the housing of the device 100 and of the thrusting elements 200 to ensure, as shown in FIGS. 14 and 15, the holding of the ferrule in position with respect to the termination element 300.

As shown in FIG. 8, in a usage configuration, once the device 100, 100′ or 101 is brought from one end of the corrugated to the other, to allow the assembly of the thrusting elements 200 on the device 100, 100′ or 101, the protection element 30, 30′ that during the movement into the corrugated is coupled to the ferrule holder 20, is made to slide along the optical fiber and away from the ferrule holder 20.

The thrusting element 201 is therefore inserted, at the ferrule 10 and positioned, dragging it longitudinally on the ferrule holder 20, between the protection element 30, 30′ and the ferrule holder 20.

Advantageously, the thrusting element 201 is inserted on the device 100, 100′ or 101 already provided with the elastic element 202 positioned in the housing A.

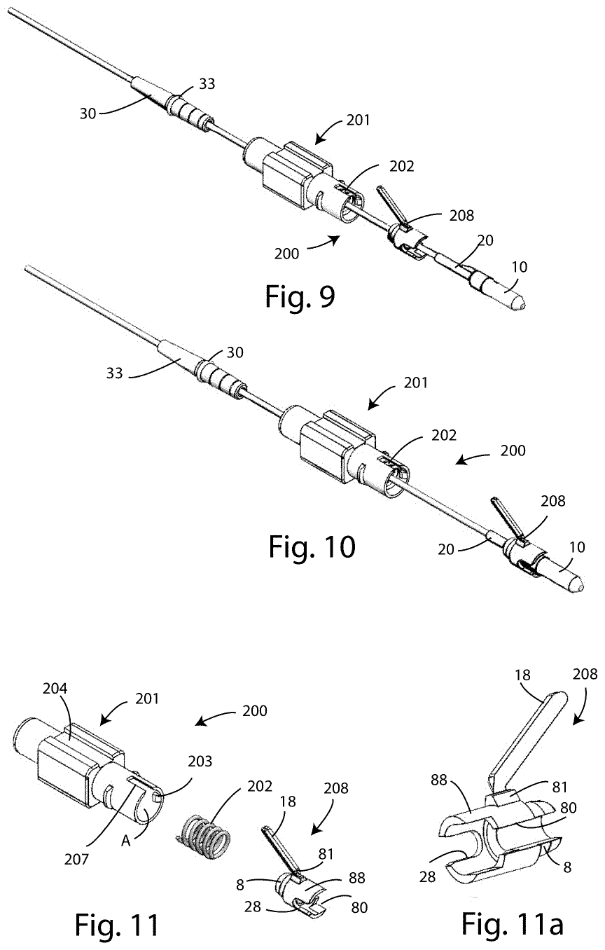

Therefore, as shown in FIG. 9, to allow a transfer of the elastic thrust of the elastic element 202 on the ferrule holder 20, and therefore on the ferrule 10, the thrust element 208 is positioned between the pusher element 201 provided with elastic element 202 and the ferrule holder 20.

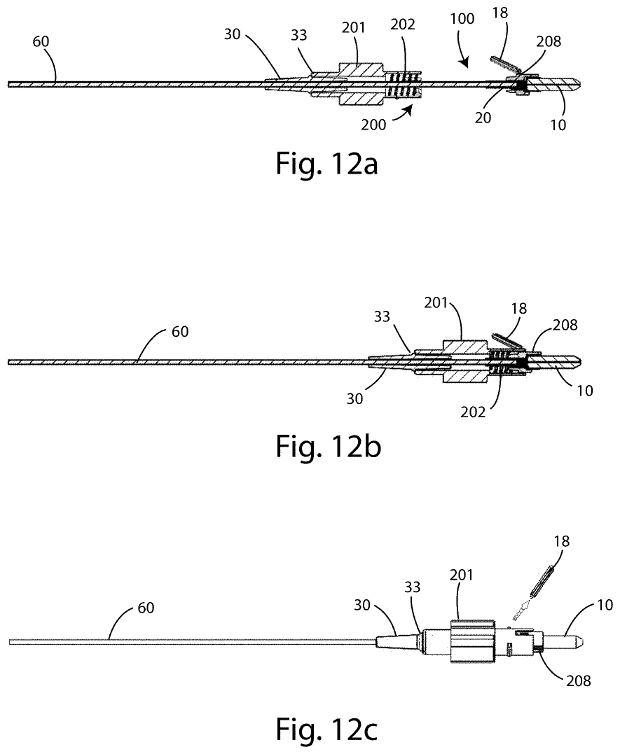

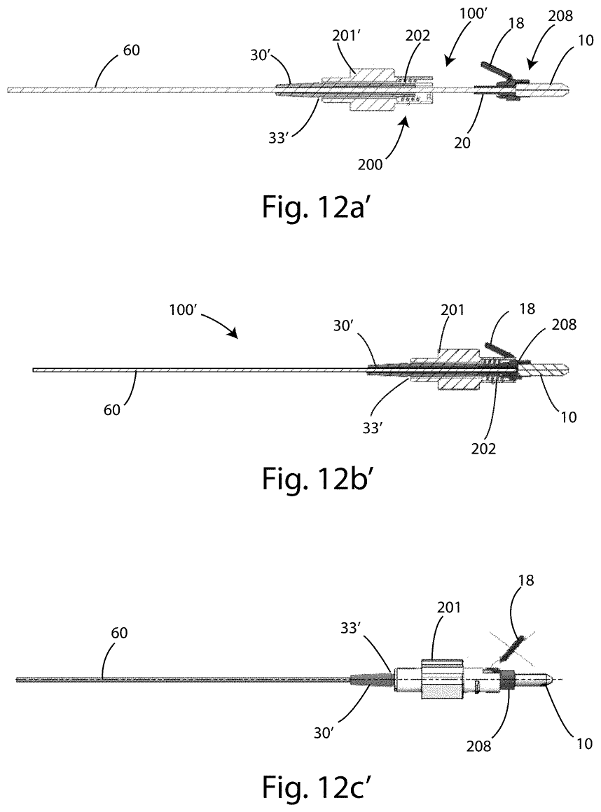

As shown in FIGS. 12a and 12a′ the protective element 30, 30′ is inserted into a proximal end of the thrusting element 201.

Advantageously, therefore, the protection element 30, 30′ plays a double role, the first of protection of the optical fiber 60 at the ferrule holder 20 during a transporting operation of the device 100, 100′ or 101, the second of protection of the optical fiber 60 at the thrusting element 201, in an assembly configuration of the connector system 1000.

FIGS. 12a and 12a′ also show a coupling between the thrust-bearing element 208 and the ferrule holder 20.

Advantageously, by inserting the opening 28 on the protuberance 27, the orientation of the coupling between the thrust bearer 208 and the ferrule holder 20 is univocal.

As shown in FIG. 12b, and in FIG. 12b′, the thrusting element 201, comprising the elastic element 202, and coupled with the protection element 30, 30′ is slid along the optical fiber to be coupled to the thrust bearer 208.

Advantageously, by inserting the opening 207 on the further reference element 81, the orientation of the coupling between the pusher element 201 and the thrust holder 208 is univocal.

Once the assembly of the thrusting elements 200 on the device 100, 100′,101 is completed, the gripping element 18 of the thrust bearer 208 is removed, as shown in FIGS. 12c and 12c′.

Therefore, as shown in FIG. 13 (where only the device 100 is shown), the device according to any embodiment of the present invention, provided with thrusting means 200, is inserted into the termination element 300.

Advantageously, both the thrusting element 201 and the termination element 300 have abutment surfaces shaped to guarantee a unique mutual coupling.

In particular, as shown in FIG. 11, the thrusting element 201 comprises a longitudinal reference track 204, made on an external surface of the thrusting element.

In the same way, as shown in FIG. 16a, on an internal surface of the termination element 300 there is a key or protrusion 304 shaped to be inserted into the track 204 and avoid incorrect assembly of the system 1000.

Advantageously, the invention according to the present invention further provides the supply of a kit for the realization of a connector system 1000 for optical fiber, comprising at least a connector device 100, 100′ or 101 according to what described above, one or more thrusting means 200, and one or more termination elements 300.

In this way, for example, it will be possible to reduce the number of components to be assembled during the cabling phase, and allow obtaining a high quality optical connection without the need for specialized personnel and thus reducing processing costs.

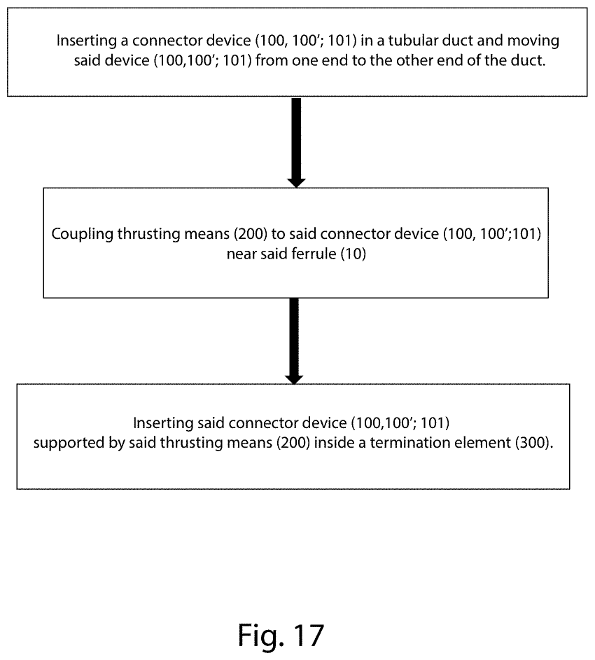

As schematized in the block diagram of FIG. 17, the assembly method of the connector system 1000 for optical fiber according to the present invention comprises the steps of: inserting the connector device 100, 100′ or 101, in a cabling channel, or tubular conduit, and moving (in particular dragging) the device 100, 100′ or 101, from one end of the duct to the other, coupling thrusting means 200 to the device 100, 100′ or 101, near the ferrule 10, and inserting the device connector 100, 100′ or 101, supported by the thrusting means 200 inside the termination element 300. Advantageously, in the method according to the present invention, the movement phase of the connector device 100, 100′ or 101, inside the tubular conduit is made easier by a reduced size of the device 100, 100′ or 101, both in the radial direction and in the longitudinal direction.

Advantageously, therefore, through the assembly of components, at least partially pre-assembled and comprising unique assembly keys, a connector system configured to allow an easier connection between two ends of optical fiber is obtained, for example by means of an optical sleeve, in particular a female-female connection element, or connector.

The present invention has so far been described with reference to preferred embodiments. It is to be understood that other embodiments may exist that pertain to the same inventive core, as defined by the scope of protection of the claims set out below.

What is claimed is:

1. A connector device for an optical fiber configured to allow transmission of an optical signal at a terminal end of the optical fiber, said device comprising:
an optical fiber portion having a ferrule at at least one terminal end;
a ferrule holder element shaped as a double hollow cup comprising a first cup having an internal diameter shaped to house a proximal portion of said ferrule and a second cup having an internal diameter smaller than said internal diameter and shaped to house said optical fiber so as to direct a coupling of said optical fiber with said ferrule, said ferule holder element further having a reference protuberance shaped as a reference tooth, on an external surface of said first cup, said protuberance extending longitudinally from an external diameter of said second cup to an external diameter of said first cup; and
a substantially cylindrical protection element slidably coupled to the optical fiber and shaped to be positioned partially overlapping, in a shape coupling, at least one end portion of said second cup, wherein said substantially cylindrical protection element is made of elastic material,
the overall configuration being such that said connector device has compact overall dimensions, both in a radial direction and in a longitudinal direction, which, in an operating condition, allows an easy handling of the connector device inside tubular ducts.

2. The connector device according to claim 1, wherein said protection element is made of rubber.

3. The connector device according to claim 1, further comprising a dragging assembly for dragging the device from one end to another end of a tubular duct, said dragging assembly comprising a dragging cable and a tubular sheath, optionally heat-shrinking, positioned at a distal end of the device to allow a protection of the ferrule and a coupling between said optical fiber and said dragging cable maintaining the small radial dimensions of the device.

4. The connector device according to the claim 3, comprising a further covering sheath positioned between said optical fiber and said tubular sheath.

5. A connector system comprising:
a connector device according to claim 1;
a termination element configured to be coupled to an optical sleeve for transmission of an optical signal between the ends of two fibers; and
a thrusting means, positioned between said connector device and said termination element configured to exert an elastic force on said ferrule.

6. The connector system according to claim 5, wherein said thrusting means comprises:
a pusher element having a substantially tubular conformation having a housing at an ending portion;
a thrust-bearing element having a substantially tubular conformation having a longitudinal opening configured to allow the mounting of the thrust-bearing element on said optical fiber, said thrust-bearing element comprising a main body shaped as a hollow cup sized to house said ferrule holder and to abut against said ferrule holder at a circular base crown of the cup; and
an elastic element, in particular a spring, positioned at said housing, configured to transfer an elastic thrust to said ferrule, via said thrust-bearing element and said ferrule holder, in an assembling configuration of said system.

7. The connector system according to claim 6, wherein said cup has a side wall provided with a slot configured to house said protuberance of said ferrule holder in a shape coupling configuration between said cup and said ferrule holder.

8. The connector system according to claim 6, wherein said thrust-bearing element has a circular abutment base shaped to be positioned in abutment with said elastic element in a configuration of a partial fitting of said thrust-bearing element into said housing.

9. The connector system according to claim 6, wherein said thrust-bearing element comprises a gripping element, optionally removable.

10. The connector system according to claim 9, wherein said pusher element comprises a longitudinal opening for housing a further reference element of said thrust-bearing element, said gripping element being connected to said further reference element.

11. (canceled)

12. A method for assembling a connector system comprising the steps of:
inserting a connector device according to claim 1, in a tubular duct and moving said device from one end to another end of the tubular duct;
coupling a thrusting means to said connector device near said ferrule; and
inserting said connector device supported by said thrusting means inside a termination element, in which said step of moving said connector device inside the tubular duct is made easy by the small dimensions of the device, both in a radial direction and in a longitudinal direction.
